(19) United States
(12) Patent Application Publication
(10) Pub. No.: US 2017/0083207 A1
(43) Pub. Date: Mar. 23, 2017

(54) INFORMATION PROCESSING APPARATUS, INFORMATION PROCESSING METHOD, AND INFORMATION PROCESSING PROGRAM

(71) Applicant: NEC CORPORATION, Tokyo (JP)

(72) Inventor: Satoru ISHII, Tokyo (JP)

(73) Assignee: NEC CORPORATION, Tokyo (JP)

(21) Appl. No.: 15/126,625

(22) PCT Filed: Dec. 26, 2014
(86) PCT No.: PCT/JP2014/084615

§ 371 Date: Sep. 16, 2016

(30) Foreign Application Priority Data
Mar. 20, 2014 (JP) 2014-059237

(51) Int. Cl. G06F 3/0481; G06F 3/0488

(52) U.S. Cl. CPC G06F 3/04817; G06F 3/0488

(57) ABSTRACT

There is disclosed an information processing apparatus for providing a user interface capable of readily adjusting a selected range, including a touch panel, a display unit, and an adjuster. The display unit displays a document and a selected range in the document in correspondence with the touch panel. On the other hand, the adjuster can adjust the size or position of the selected range in accordance with a touch operation on an icon by causing the display unit to display the icon while the selected range is displayed.

### TECHNICAL FIELD

The present invention relates to an information processing apparatus, an information processing method, and an information processing program.

### BACKGROUND ART

In the above technical field, patent literature 1 discloses a technique of selecting a paragraph, sentence, phrase, or word designated by the user by circling, with a finger, a portion to be selected on the display screen of a smartphone or tablet.

### CITATION LIST

### Patent Literature

Patent literature 1: Japanese Patent Laid-Open No. 2013-186720

### SUMMARY OF THE INVENTION

### Technical Problem

In the technique described in the above literature, however, an actually selected target does not always coincide with a target the user wants to select from a display document. Especially, it is impossible to accurately select a document element such as a paragraph, sentence, phrase, or word included in a display document from the touch panel of a smartphone, a tablet, or the like.

The present invention enables to provide a technique of solving the above-described problem.

### Solution to Problem

One aspect of the present invention provides an information processing apparatus comprising:

a touch panel;

a display unit that displays a document and a selected range in the document in correspondence with the touch panel; and

an adjuster that adjusts the selected range in accordance with a touch operation on an icon by causing the display unit to display the icon while the selected range is displayed.

Another aspect of the present invention provides an information processing method comprising:

displaying a document and a selected range in the document on a display unit in correspondence with a touch panel; and

adjusting the selected range in accordance with a touch operation on an icon by causing the display unit to display the icon while the selected range is displayed.

Still other aspect of the present invention provides an information processing program for causing a computer to execute a method, comprising:

displaying a document and a selected range in the document on a display unit in correspondence with a touch panel; and

adjusting the selected range in accordance with a touch operation on an icon by causing the display unit to display the icon while the selected range is displayed.

### Advantageous Effects of Invention

According to the present invention, it is possible to provide a user interface capable of readily adjusting a selected range.

### BRIEF DESCRIPTION OF DRAWINGS

FIG. 1 is a block diagram showing the arrangement of an information processing apparatus according to the first embodiment of the present invention;

FIG. 2 is a view showing an overview of processing by an information processing apparatus according to the second embodiment of the present invention;

FIG. 3 is a view for explaining range selection in the information processing apparatus according to the second embodiment of the present invention;

FIG. 4A is a view showing the outer appearance of the information processing apparatus according to the second embodiment of the present invention;

FIG. 4B is a block diagram showing the arrangement of the information processing apparatus according to the second embodiment of the present invention;

FIG. 5 is a block diagram showing the functional arrangement of a screen operation processor according to the second embodiment of the present invention;

FIG. 6 is a block diagram showing the functional arrangement of an operation acceptor according to the second embodiment of the present invention;

FIG. 7 is a block diagram showing the functional arrangement of an operation analyzer according to the second embodiment of the present invention;

FIG. 8A is a block diagram showing the functional arrangement of an icon generator according to the second embodiment of the present invention;

FIG. 8B is a table showing the structure of an icon function table according to the second embodiment of the present invention;

FIG. 9 is a block diagram showing the functional arrangement of a display controller according to the second embodiment of the present invention;

FIG. 10 is a block diagram showing the functional arrangement of a user operation determiner according to the second embodiment of the present invention;

FIG. 11 is a flowchart illustrating the procedure of screen operation processing by the information processing apparatus according to the second embodiment of the present invention;

FIG. 12A is a flowchart illustrating the procedure of icon generation display processing according to the second embodiment of the present invention;

FIG. 12B is a flowchart illustrating the procedure of selected range adjustment processing according to the second embodiment of the present invention;

FIG. 13 is a view for explaining range selection in an information processing apparatus according to the third embodiment of the present invention;

FIG. 14 is a table showing the structure of an icon function table according to the third embodiment of the present invention;

FIG. 15 is a flowchart illustrating the procedure of selected range adjustment processing according to the third embodiment of the present invention;

FIG. 16 is a view for explaining range selection in an information processing apparatus according to the fourth embodiment of the present invention;

FIG. 17 is a table showing the structure of an icon function table according to the fourth embodiment of the present invention;

FIG. 18 is a flowchart illustrating the procedure of selected range adjustment processing according to the fourth embodiment of the present invention;

FIG. 19 is a view for explaining range selection in an information processing apparatus according to the fifth embodiment of the present invention;

FIG. 20 is a table showing the structure of an icon function table according to the fifth embodiment of the present invention;

FIG. 21 is a flowchart illustrating the procedure of selected range adjustment processing according to the fifth embodiment of the present invention;

FIG. 22 is a table showing the structure of an icon function table according to the sixth embodiment of the present invention;

FIG. 23 is a flowchart illustrating the procedure of selected range adjustment processing according to the sixth embodiment of the present invention;

FIG. 24 is a view for explaining range selection in an information processing apparatus according to the seventh embodiment of the present invention;

FIG. 25 is a table showing the structure of an icon function table according to the seventh embodiment of the present invention; and

FIG. 26 is a flowchart illustrating the procedure of selected range adjustment processing according to the seventh embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

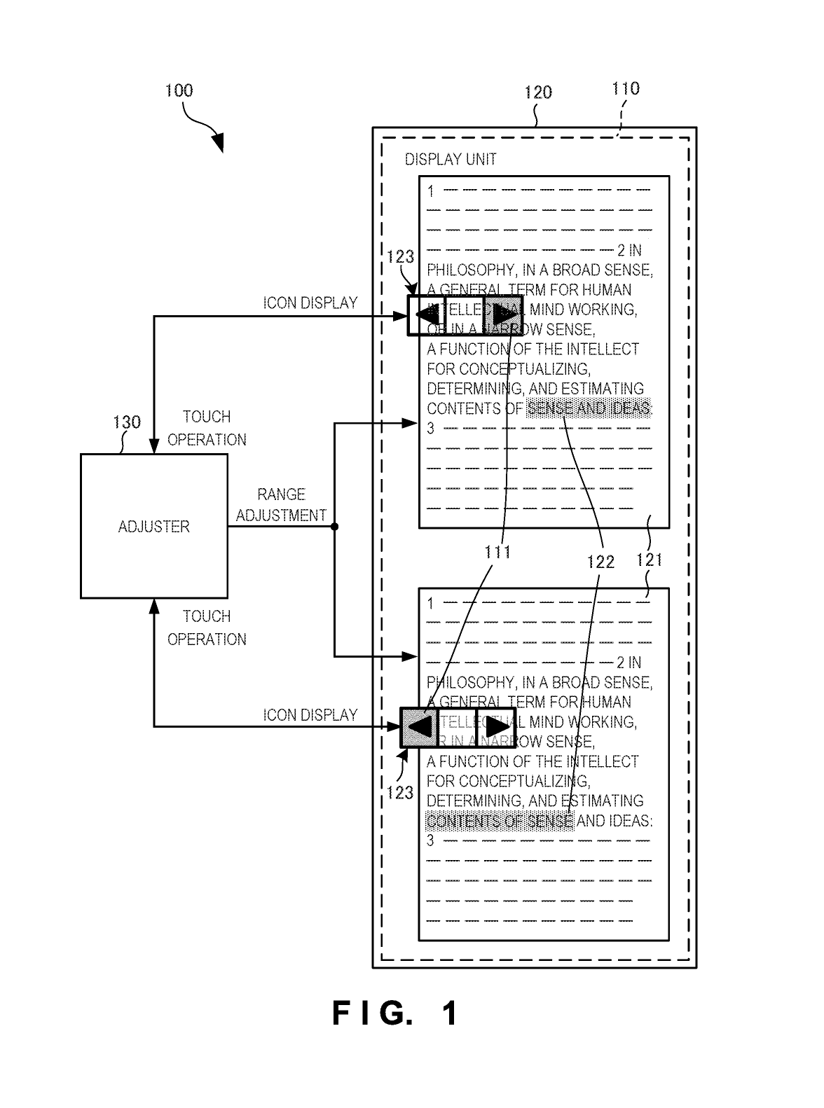

An information processing apparatus 100 according to the first embodiment of the present invention will be described with reference to FIG. 1. The information processing apparatus 100 is an apparatus for controlling selection of a range on a display screen.

As shown in FIG. 1, the information processing apparatus 100 includes a touch panel 110, a display unit 120, and an adjuster 130. The display unit 120 displays a document 121 and a selected range 122 in the document 121 in correspondence with the touch panel 110. The adjuster 130 causes the display unit 120 to display an icon 123 while the selected range 122 is displayed, and adjusts the selected range 122 in accordance with a touch operation 111 on the icon 123.

For example, the display unit 120 displays the document 121 and the selected range 122 in the document on a display including the touch panel 110. The adjuster 130 displays, on the display, an icon for adjusting the selected range 122. The user touches the icon to adjust the selected range.

According to this embodiment, it is possible to provide a user interface capable of readily adjusting a selected range, thereby allowing the user to readily select a target he/she wants to select from a display document.

### Second Embodiment

An information processing apparatus according to the second embodiment of the present invention will be described next. The information processing apparatus according to this embodiment makes an icon for adjusting a selected range appear on a screen when a range in a document displayed on the screen is selected, and changes the size of the selected range by one character by a touch operation on the icon. In the appearance of the icon, interference with display of the document is avoided by automatically moving the icon to a position outside the selected range, displaying a translucent icon, or starting display of the icon by a touch within the selected range.

<<Overview of Processing>>

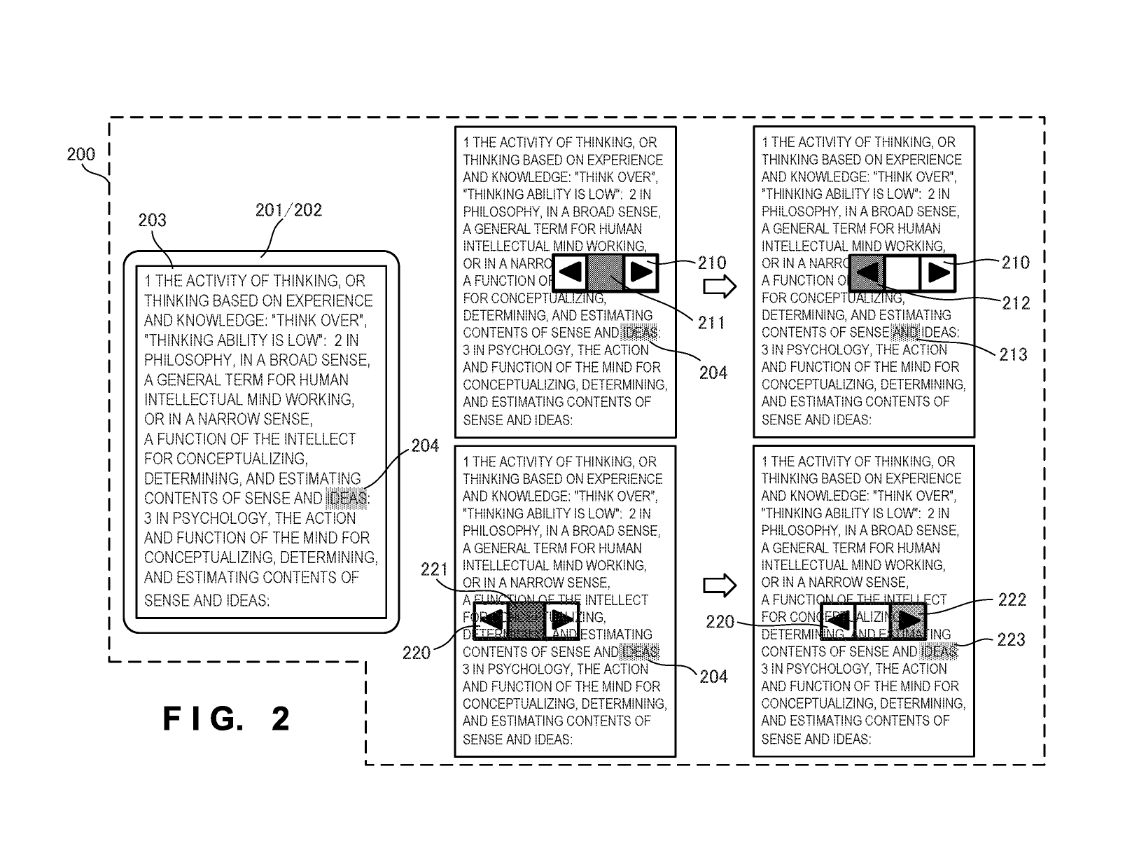

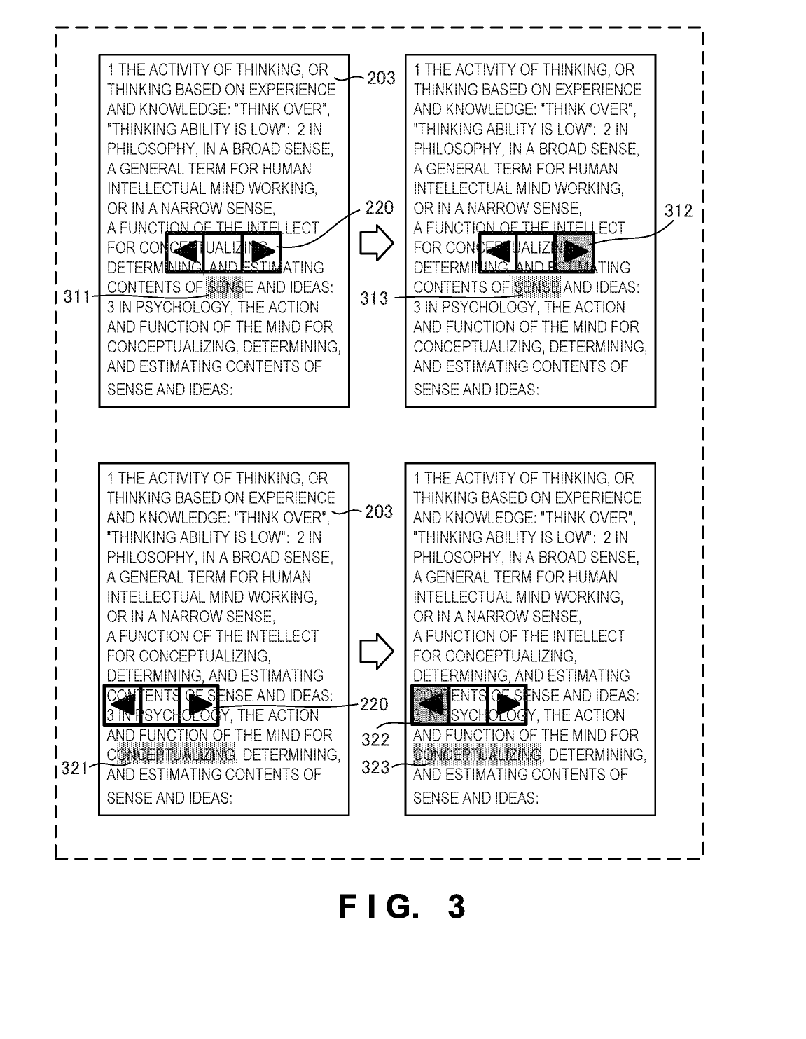

An overview of processing by an information processing apparatus 200 according to this embodiment will be described below with reference to FIGS. 2 and 3.

FIG. 2 is a view showing an overview of processing by the information processing apparatus 200 according to this embodiment. FIG. 2 shows an overview of processing common to all embodiments in this specification. FIG. 2 shows some examples of processing according to this embodiment for range selection by the user on a touch panel 201 and a display panel 202 of the information processing apparatus 200. Note that the shape of the icon according to this embodiment is not limited as long as the selected range can be adjusted rightward/leftward.

The left view of FIG. 2 shows a case in which the user designates “ideas” 204 as a selected range in a display document 203.

The two upper right views of FIG. 2 show a case in which an opaque icon 210 appears and movement of the selected range in a word unit is selected as a mode by a center touch 211. In this case, a left touch 212 moves the selected range from the “ideas” 204 to “and” 213.

The two lower right views of FIG. 2 show a case in which a translucent icon 220 appears and enlargement of the selected range in a character unit is selected as a mode by a center touch 221. In this case, a right touch 222 enlarges the selected range from the “ideas” 204 to “ideas:” 223.

As described above, when the user adjusts the selected range to a desired one by mode setting by the center touch on the icon, and a left/right touch, it is possible to reliably select a target which cannot be narrowed down by designation of the selected range 204 by the user.

(Range Selection of Embodiment)

FIG. 3 is a view for explaining range selection in the information processing apparatus 200 according to this embodiment. FIG. 3 shows an example of displaying the translucent icon but the present invention is not limited to this. Note that in FIG. 3, the same reference numerals denote the same components as in FIG. 2.

The upper left view of FIG. 3 shows a state in which “sens” 311 has been designated in the display document 203 selected by the user. The upper right view of FIG. 3 shows a state in which the “sens” 311 has been enlarged by one character to “sense” 313 by a right touch 312 of the icon 220.

The lower left view of FIG. 3 shows a state in which “onceptualizing” 321 has been designated in the display document 203 selected by the user. The lower right view of FIG. 3 shows a state in which the “onceptualizing” 321 has been enlarged by one character to “conceptualizing” 323 by a left touch 322 of the icon 220.

Note that FIG. 3 shows enlargement of the size of the selected range but reduction is also possible. FIG. 3 shows a case for clearly explaining an example of adjustment of the selected range according to this embodiment. In fact, however, it is often controlled to select a word even by designating part of the word. The initial selected range designation method is not limited. For example, any operation for range designation, such as a touch on the touch panel 201 by the user, a stroke for surrounding the selected range, and an operation by a keyboard or pointing device, may be included. A character string within the selected range may be stored in a database (to be referred to as a DB hereinafter), and used for paste processing for document creation or the like in subsequent processing.

<<Information Processing Apparatus>>

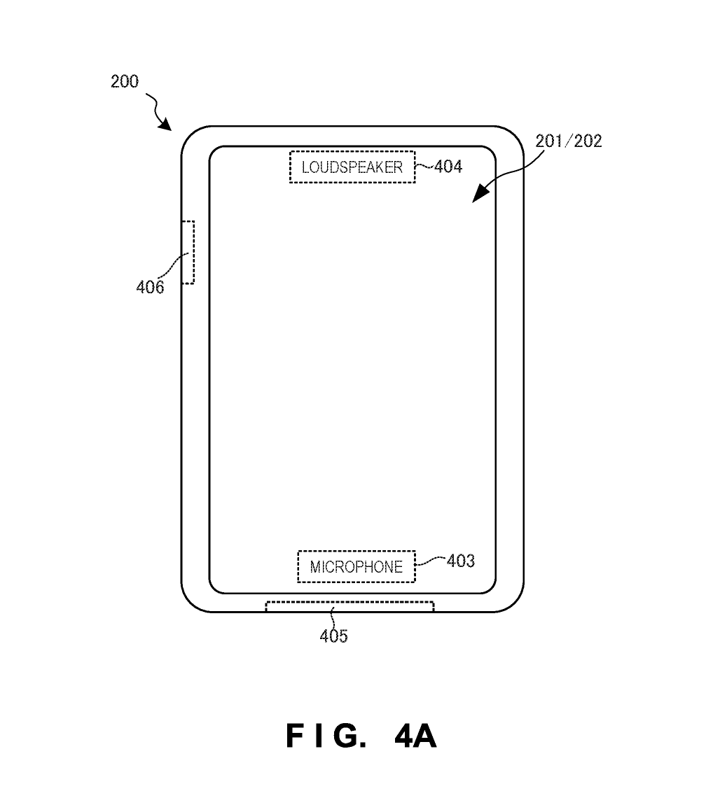

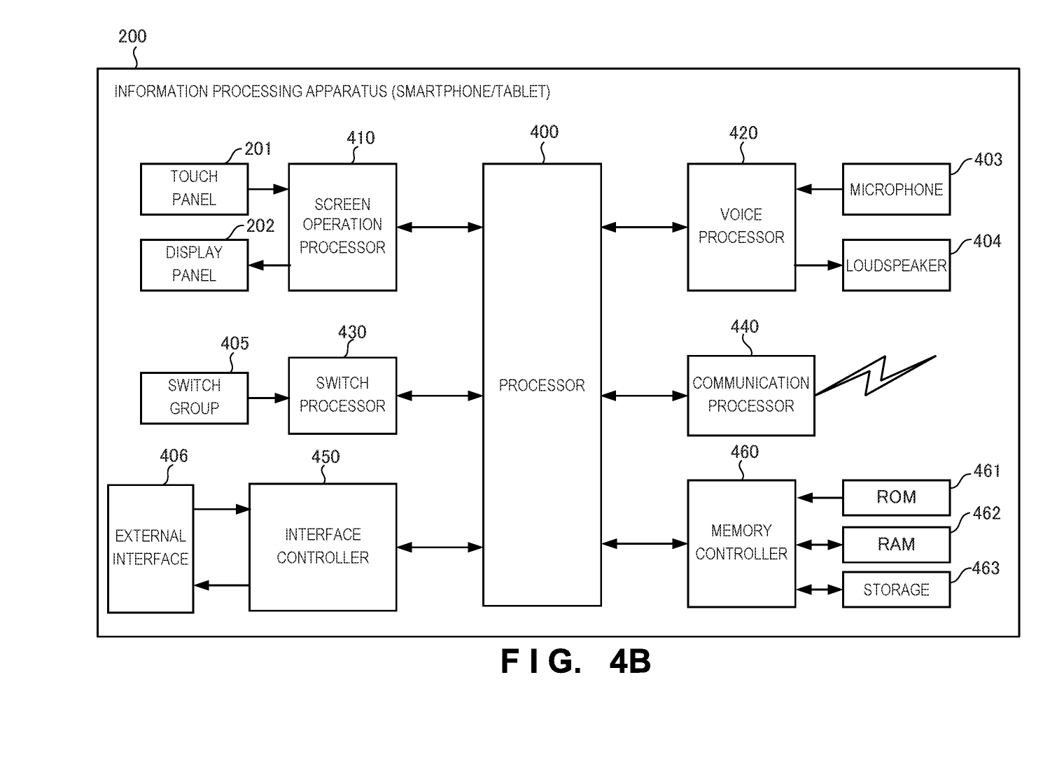

FIG. 4A is a view showing the outer appearance of the information processing apparatus 200 according to this embodiment. Note that FIG. 4A shows a portable terminal using a touch panel, such as a smartphone or tablet. However, the information processing apparatus is not limited to the smartphone, the tablet, or the like, and any information processing apparatus using a touch panel can be adopted.

In the information processing apparatus 200, the touch panel 201 and the display panel 202 function as an operation unit and a display unit, respectively. The information processing apparatus 200 includes a microphone 403 and a loudspeaker 404 as a voice input/output function. The information processing apparatus 200 also includes a switch group 405 including a power switch. Furthermore, the information processing apparatus 200 includes an external interface 406 used for external input/output device connection and communication connection.

(Functional Arrangement of Information Processing Apparatus)

FIG. 4B is a block diagram showing the arrangement of the information processing apparatus 200 according to this embodiment. Note that FIG. 4B shows the basic arrangement of the portable terminal using the touch panel, such as a smartphone or tablet. The present invention, however, is not limited to this. Each component shown in FIG. 4B may be implemented by a single hardware component, software by including a proprietary processor to execute a program, or firmware by combining hardware and software. Each component shown in FIG. 4B is separated from other components to independently implement its function. In fact, however, each component is implemented by a combination of multilayer controls from bottom layer control by basic hardware and OS (Operating System) and input/output control to top layer control by an application program.

A processor 400 includes at least one CPU (Central Processing Unit), and controls the overall information processing apparatus 200. Note that the processor 400 desirably incorporates a unique memory. A screen operation processor 410 is a component for performing processing according to this embodiment. The screen operation processor 410 accepts a user operation input from the touch panel 201, changes a display screen in correspondence with the user operation input, and displays the screen on the display panel 202. Note that the screen operation processor 410 may be implemented by executing an associated program by the processor 400 but an independent screen operation processor is desirably provided. A voice processor 420 processes a voice input from the microphone 403 to, for example, transmit the voice input via a communication processor 440 or send a user voice instruction changed to a user operation input from the touch panel 201. The voice processor 420 generates a notification/warning to the user, a video reproduction voice, or the like, and outputs a voice from the loudspeaker. The voice processor 420 is also desirably provided with a voice processing processor independent of the processor 400.

A switch processor 430 executes processing based on a switch input from the switch group 405. The communication processor 440 transmits/receives data via a network. An interface controller 450 controls data input/output to/from an input/output device connected via the external interface 406. The communication processor 440 is also desirably provided with a voice processing processor independent of the processor 400. For example, a memory controller 460 controls exchange of data and programs between the processor 400 and a ROM (Read Only Memory) 461 which is formed by a flash memory and the like, RAM (Random Access Memory) 462, and storage 463. The memory controller 460 is also desirably provided with a voice processing processor independent of the processor 400.

The screen operation processor 410 according to this embodiment will be described in more detail below.

(Screen Operation Processor)

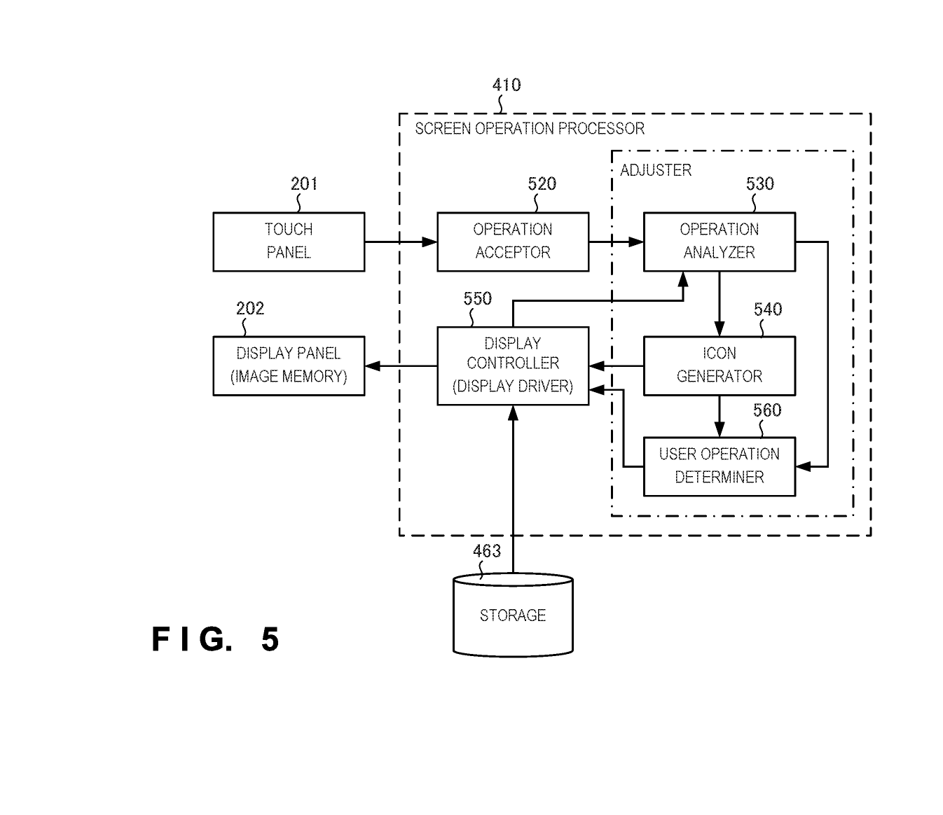

FIG. 5 is a block diagram showing the functional arrangement of the screen operation processor 410 according to this embodiment.

The screen operation processor 410 includes an operation acceptor 520, an operation analyzer 530, an icon generator 540, a display controller 550, and a user operation determiner 560. The operation acceptor 520 accepts a user operation from the touch panel 201, and acquires a touch position and an operation. The operation analyzer 530 analyzes operation contents in consideration of information of the display screen based on the user operation and position accepted by the operation acceptor 520. In this embodiment, the operation analyzer 530 especially detects the setting operation of a selected range and a touch operation on an icon. In accordance with range selection by the user, the icon generator 540 generates an icon having a function of adjusting the selected range, and makes it appear on the display screen. The display controller 550 includes a display driver, and reads out display information in the storage 463 and controls the screen on the display panel 202 by changing an image memory to implement an operation desired by the user on the display screen in accordance with the determination result of the user operation determiner 560. In this embodiment, the display controller 550 also controls display of the icon generated by the icon generator 540 on the display panel 202. The user operation determiner 560 determines the operation desired by the user based on the operation contents analyzed by the operation analyzer 530. In this embodiment, the user operation determiner 560 determines the range selection operation by the user and the touch operation on the icon, adjusts the range selection, and reflects it to display on the display panel 202. The operation analyzer 530, icon generator 540, and user operation determiner 560 may be integrated as an adjuster.

Note that the functional components shown in FIG. 5 may be implemented by the processing of the processor of the screen operation processor 410, or some functional components may be processed by a proprietary processor to increase the processing speed. Each functional component shown in FIG. 5 is limited to the operation of the screen operation processor 410 but may exchange data with other components of the information processing apparatus 200 shown in FIG. 4B.

(Operation Acceptor)

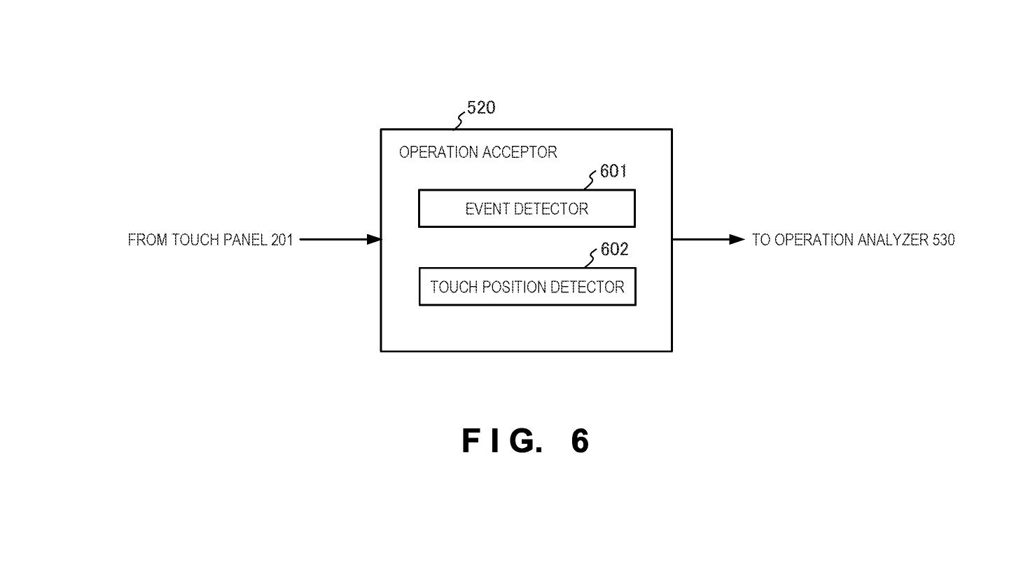

FIG. 6 is a block diagram showing the functional arrangement of the operation acceptor 520 according to this embodiment. The operation acceptor 520 accepts a user operation from the touch panel 201, and acquires a touch position and an operation.

The operation acceptor 520 includes an event detector 601 and a touch position detector 602. The event detector 601 detects the start of some operation from the user on the touch panel 201, and starts accepting operation data. The touch position detector 602 detects position coordinates on the touch panel 201 touched by a user's finger.

(Operation Analyzer)

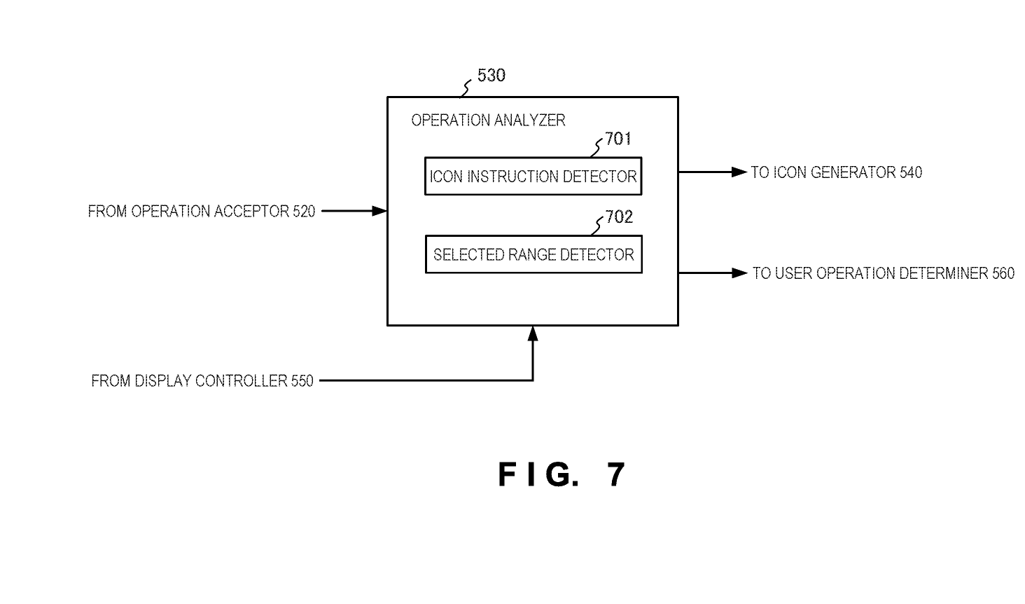

FIG. 7 is a block diagram showing the functional arrangement of the operation analyzer 530 according to this embodiment. The operation analyzer 530 analyzes operation contents in consideration of the information of the display screen based on the user operation and position accepted by the operation acceptor 520.

The operation analyzer 530 includes an icon instruction detector 701 and a selected range detector 702. Based on the touch position of the user from the operation acceptor 520, the icon instruction detector 701 detects a touch operation by the user on the displayed icon. Based on the touch position of the user from the operation acceptor 520, the selected range detector 702 detects the range selected by the user from the display document.

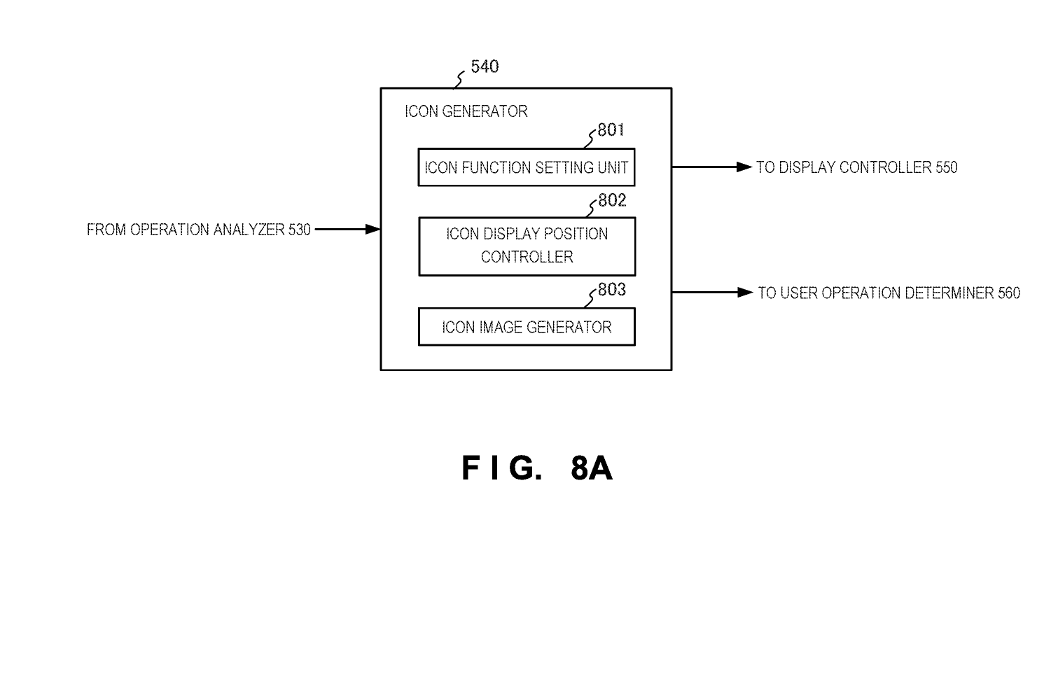

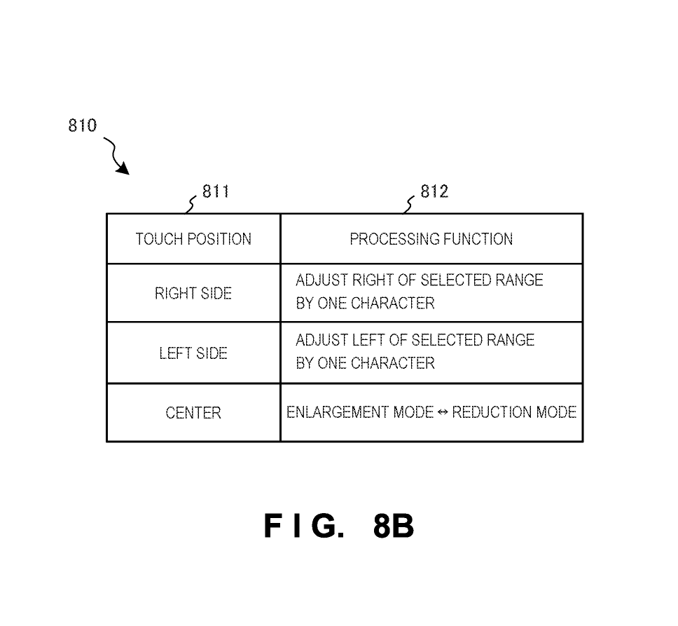

(Icon Generator) FIG. 8A is a block diagram showing the functional arrangement of the icon generator 540 according to this embodiment. In accordance with a range selection operation by the user, the icon generator 540 generates an icon having a function of adjusting the selected range, and makes it appear on the display screen.

The icon generator 540 includes an icon function setting unit 801, an icon display position controller 802, and an icon image generator 803. The icon function setting unit 801 sets a function corresponding to a touch operation by the user on the icon appearing on the display screen. This function is implemented in cooperation with the user operation determiner 560. The icon display position controller 802 controls a position at which the generated icon is to appear on the display screen. The icon image generator 803 generates an image of the icon which is to appear on the display screen.

FIG. 8B is a table showing the structure of an icon function table 810 according to this embodiment. The icon function table 810 stores the function set by the icon function setting unit 801 according to this embodiment. Processing corresponding to the touch position of the icon in the icon function table 810 is used by the user operation determiner 560.

The icon function table 810 stores a processing function 812 in correspondence with a touch position 811. In this embodiment, if the right side of the icon is touched, the right of the selected range is adjusted by one character in accordance with the mode. If the left side of the icon is touched, the left of the selected range is adjusted by one character in accordance with the mode. If the center of the icon is touched, the mode is switched between an enlargement mode for enlarging the selected range and a reduction mode for reducing the selected range. Note that mode setting by a center touch on the icon is not limited to this. For example, a switch for switching whether or not to adjust the selected range may be adopted, or the mode may be switched between a selected range adjustment mode and a copy mode for storing the selected range.

(Display Controller)

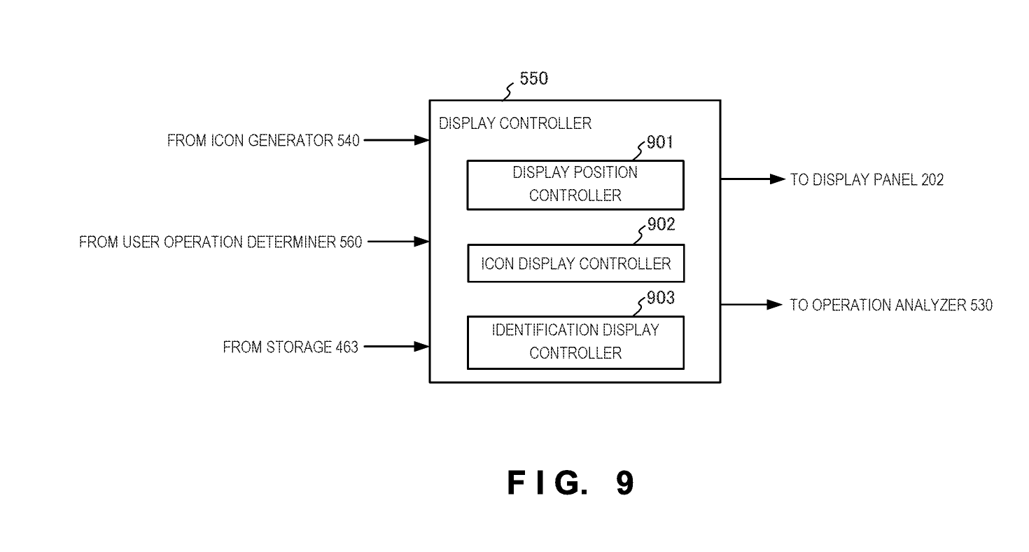

FIG. 9 is a block diagram showing the functional arrangement of the display controller 550 according to this embodiment. The display controller 550 includes a display driver, and reads out display information in the storage 463 to display it on the display panel 202 while displaying, on the display panel 202, the icon for adjusting the selected range.

The display controller 550 includes a display position controller 901, an icon display controller 902, and an identification display controller 903. The display position controller 901 controls a position of the display information read out from the storage 463 to be displayed. In this embodiment, the display position controller 901 controls the display position of the document. The icon display controller 902 controls to display the icon generated by the icon generator 540 at a predetermined position on the display panel 202. The identification display controller 903 controls to identifiably display the selected range of the document and the touch operation on the icon on the display screen.

(User Operation Determiner)

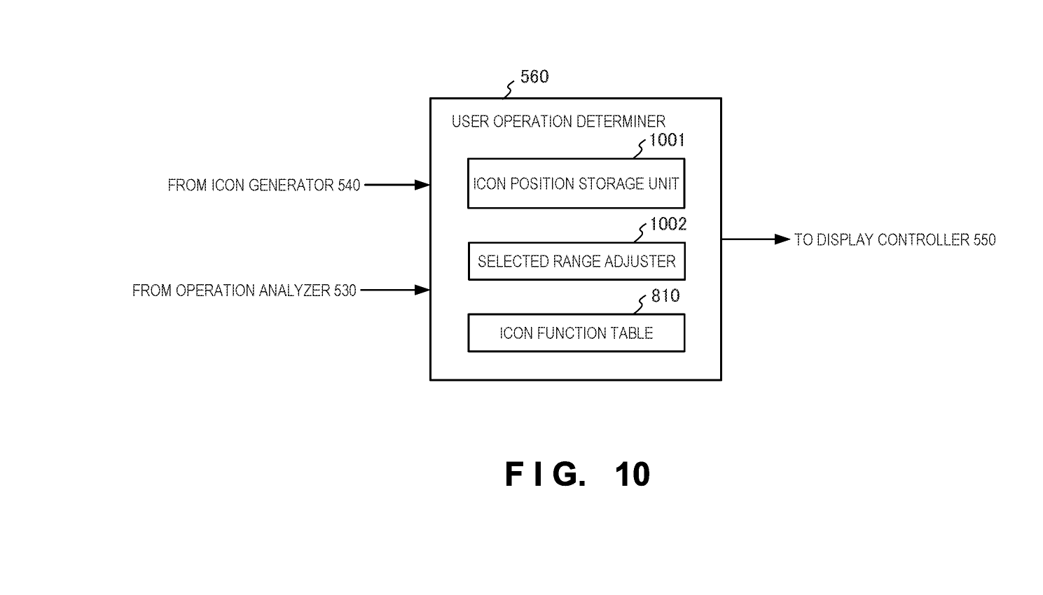

FIG. 10 is a block diagram showing the functional arrangement of the user operation determiner 560 according to this embodiment. The user operation determiner 560 determines the operation desired by the user based on the operation contents analyzed by the operation analyzer 530. In this embodiment, the user operation determiner 560 determines the range selection operation by the user and the touch operation on the icon, adjusts the range selection, and reflects it to display on the display panel 202. Note that the user operation determiner 560 may be incorporated in the icon generator 540.

The user operation determiner 560 includes an icon position storage unit 1001, a selected range adjuster 1002, and the icon function table 810. The icon position storage unit 1001 stores the current icon display position, and uses it to determine the touch operation by the user. The selected range adjuster 1002 adjusts the selected range using the icon function table 810 based on the touch operation by the user. The icon function table 810 is a table set by the icon function setting unit 801 of the icon generator 540.

<<Procedure of Screen Operation Processing>>

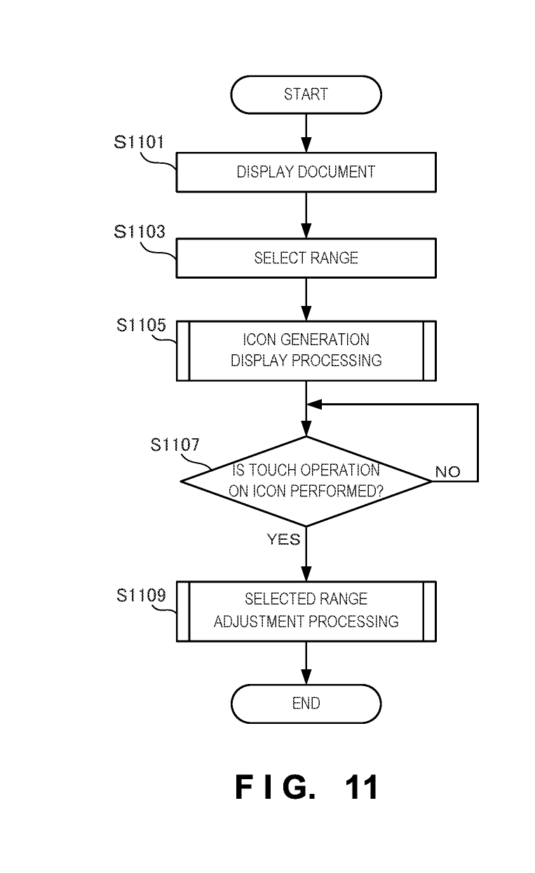

FIG. 11 is a flowchart illustrating the procedure of screen operation processing by the information processing apparatus 200 according to this embodiment. This flowchart implements the respective functional components of the screen operation processor 410 when executed by the processor 400 or the CPU of the screen operation processor 410. A case in which the CPU of the screen operation processor 410 executes the flowchart will be described.

In step S1101, the screen operation processor 410 displays a predetermined portion of a document designated, by the user, to be displayed. For example, as shown in FIG. 3, a page of “thought” of a Japanese dictionary is displayed. In step S1103, the screen operation processor 410 selects a range based on a selection operation in the document by the user using the touch panel 201 and the like, and identifiably displays the range. When the range in the display document is selected, the screen operation processor 410 executes, in step S1105, icon generation display processing of generating and displaying an icon for adjusting the selected range.

In step S1107, the screen operation processor 410 waits for a touch operation on the icon by the user. If the user performs a touch operation on the icon, the screen operation processor 410 executes, in step S1109, selected range adjustment processing of adjusting the selected range using the icon which has appeared.

(Icon Generation Display Processing)

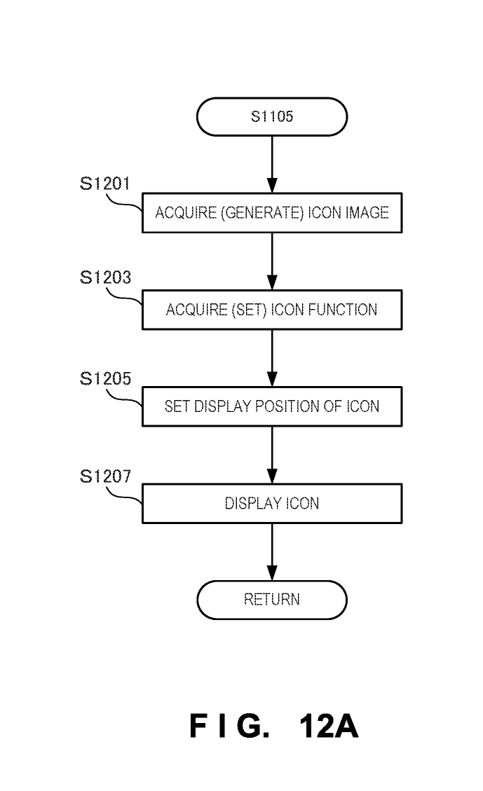

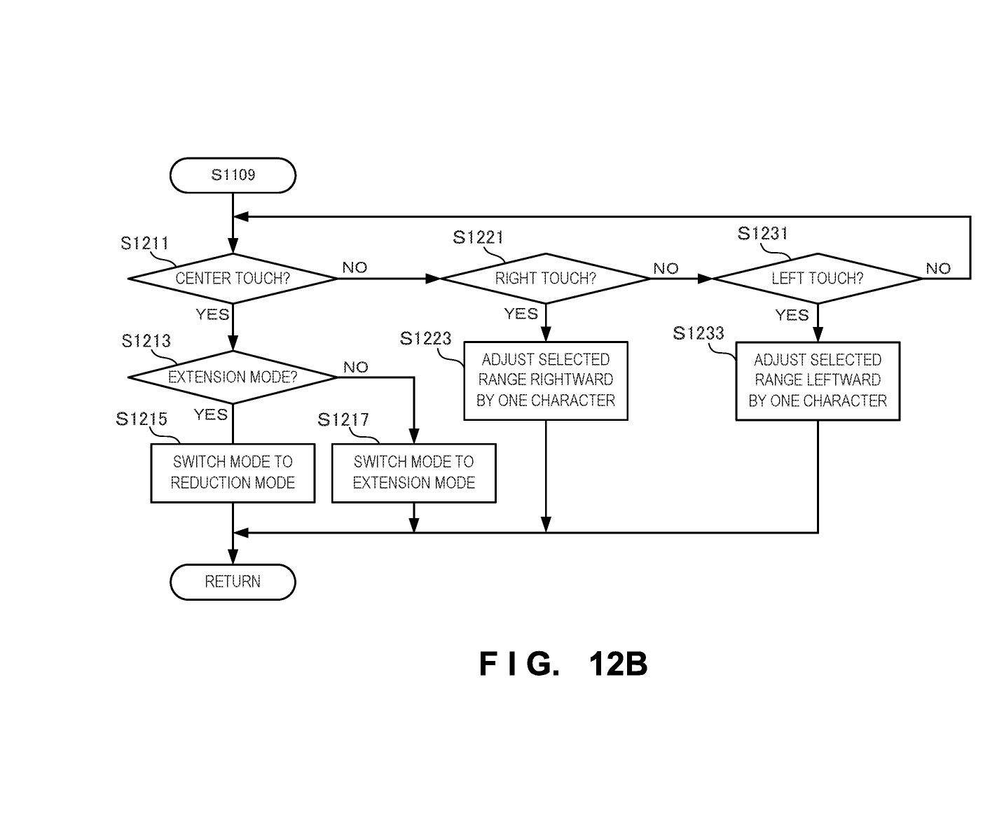

FIG. 12A is a flowchart illustrating the procedure of the icon generation display processing (S1105) according to this embodiment.

In step S1201, the screen operation processor 410 acquires or generates an icon image to be displayed. In step S1203, the screen operation processor 410 acquires or sets an icon function. In step S1205, the screen operation processor 410 sets the display position of the icon. If the icon is opaque, the display position is adjusted to display the icon at a position which does not overlap the selected range. By making the icon translucent, it becomes unnecessary to control the display position so the icon does not overlap the selected range. Furthermore, by making the icon appear in accordance with detection of a touch operation on the selected range by the user, it is possible to prevent the icon from unnecessarily appearing. In step S1207, the screen operation processor 410 superimposes and displays the generated icon on the document on the display panel 202.

(Selected Range Adjustment Processing)

FIG. 12B is a flowchart illustrating the procedure of the selected range adjustment processing (S1109) according to this embodiment.

In step S1211, the screen operation processor 410 determines whether the operation is a center touch on the icon. If the operation is a center touch, the screen operation processor 410 determines in step S1213 whether the current mode is the extension mode. If the current mode is the extension mode, the screen operation processor 410 switches the mode to the reduction mode in step S1215; otherwise, the screen operation processor 410 switches the mode to the extension mode in step S1217. Note that mode switching by a center touch is not limited to this, as described above.

If the operation is not a center touch, the screen operation processor 410 determines in step S1221 whether the operation is a right touch. If the operation is a right touch, the screen operation processor 410 adjusts, in step S1223, the selected range rightward by one character in accordance with the mode. In the case of the extension mode at the right end, the selected range is extended to the left end of the lower line. In the case of the reduction mode at the left end, the selected range is reduced to the right end of the upper line.

If the operation is neither a center touch nor a right touch, the screen operation processor 410 determines in step S1231 whether the operation is a left touch. If the operation is a left touch, the screen operation processor 410 adjusts, in step S1233, the selected range leftward by one character in accordance with the mode. In the case of the enlargement mode at the left end, the selected range is extended to the right end of the upper line. In the case of the reduction mode at the right end, the selected range is reduced to the left end of the lower line.

Note that this embodiment has exemplified the case of horizontal writing. In the case of vertical writing as well, setting and adjustment of the selected range can be implemented in the same manner.

According to this embodiment, it is possible to finely adjust the size of the selected range rightward or leftward by one character by a right or left touch on the icon, thereby making an actually selected target accurately coincide with a target the user wants to select from the display document.

### Third Embodiment

An information processing apparatus according to the third embodiment of the present invention will be described next. The information processing apparatus according to this embodiment is different from that according to the second embodiment in that the position of a selected range is moved by one character by a touch operation on an icon. The remaining components and operations are the same as those in the second embodiment. Hence, the same reference numerals denote the same components and operations, and a detailed description thereof will be omitted.

(Range Selection of Embodiment)

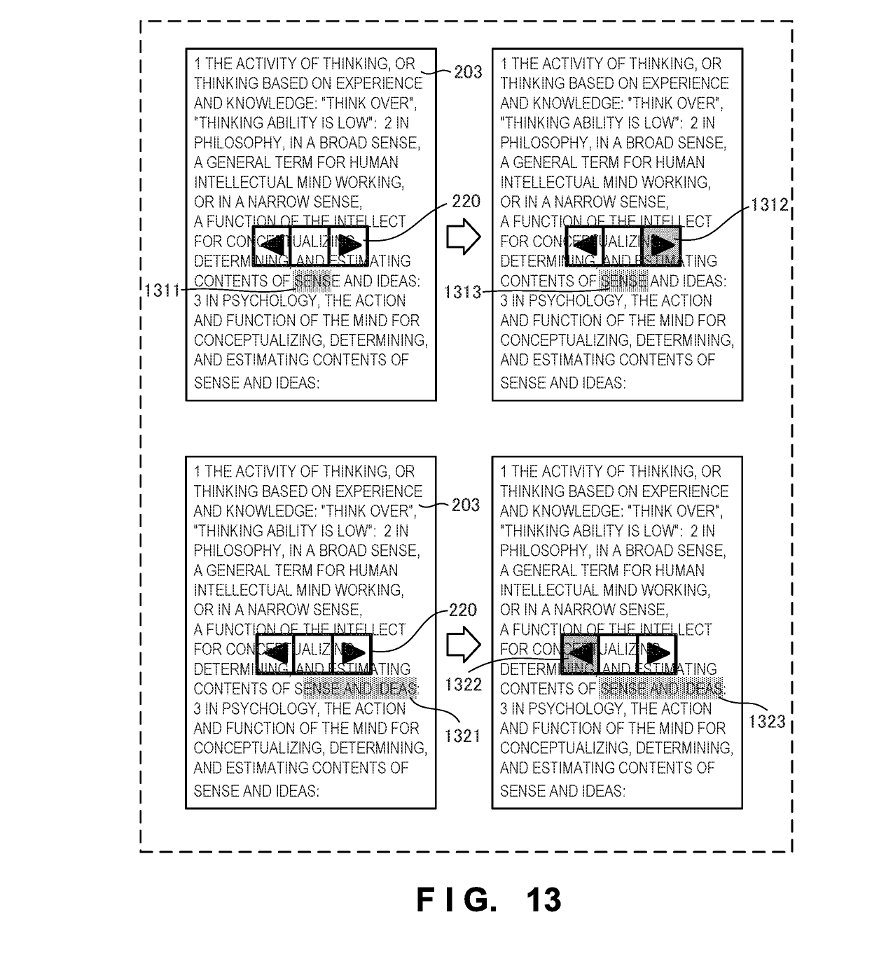

FIG. 13 is a view for explaining range selection in the information processing apparatus according to this embodiment. FIG. 13 shows an example of displaying a translucent icon but the present invention is not limited to this. Note that in FIG. 13, the same reference numerals denote the same components as in FIG. 2.

The upper left view of FIG. 13 shows a state in which “sens” 1311 has been designated in a display document 203 selected by the user. In the upper right view of FIG. 13 shows a state in which the “sens” 1311 has been moved by one character to “sense” 1313 by a right touch 1312 on an icon 220.

The lower left view of FIG. 13 shows a state in which “ense and ideas:” 1321 has been designated in the display document 203 selected by the user. The lower right view of FIG. 13 shows a state in which the “ense and ideas:” 1321 has been moved by one character to “sense and ideas” 1323 by a left touch 1322 on the icon 220.

Note that FIG. 13 shows a case for clearly explaining an example of adjustment of the selected range according to this embodiment. In fact, however, it is often controlled to select a word even by designating part of the word.

(Icon Generator)

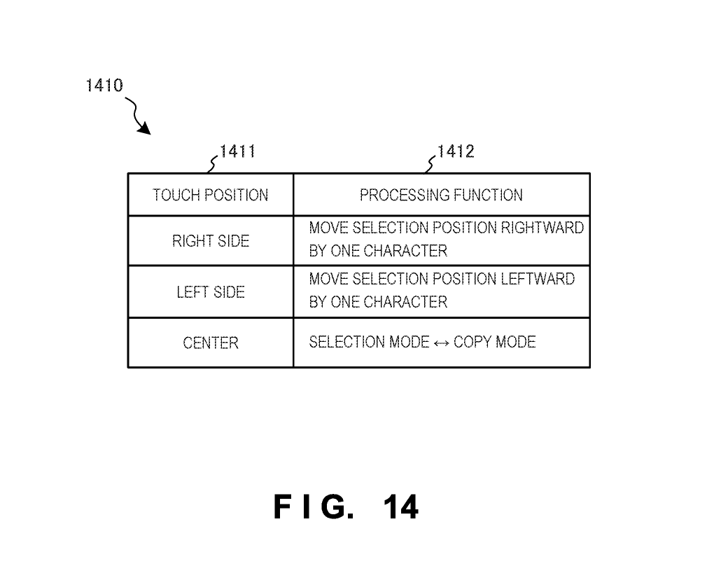

FIG. 14 is a table showing the structure of an icon function table 1410 according to this embodiment. The icon function table 1410 is set by an icon generator 540, and used by a user operation determiner 560 to adjust a selected range.

The icon function table 1410 stores a processing function 1412 in correspondence with a touch position 1411. In this embodiment, if the right side of the icon is touched, the position of the selected range is moved rightward by one character. If the left side of the icon is touched, the position of the selected range is moved leftward by one character. If the center of the icon is touched, the mode is switched between a selection mode for setting a selected range and a copy mode for storing a selected range for a copy. Note that mode setting by a center touch on the icon is not limited to this. For example, a switch for switching whether or not to adjust the selected range may be adopted.

(Selected Range Adjustment Processing)

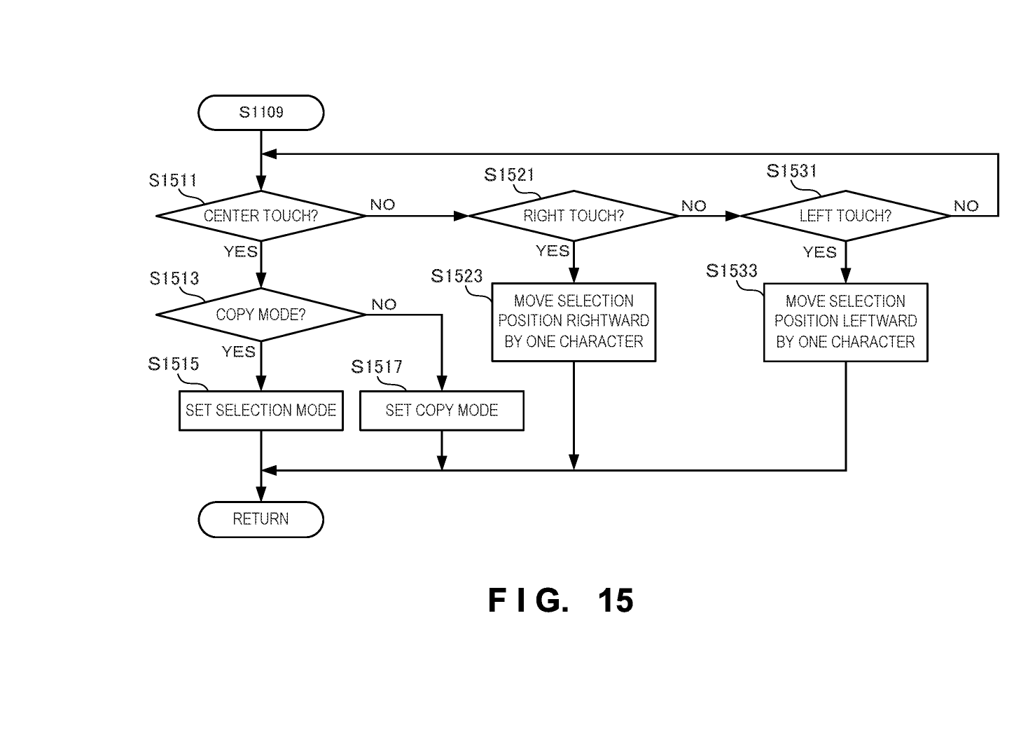

FIG. 15 is a flowchart illustrating the procedure of selected range adjustment processing (S1109) according to this embodiment.

In step S1511, a screen operation processor 410 determines whether the operation is a center touch on the icon. If the operation is a center touch, the screen operation processor 410 determines in step S1513 whether the current mode is the copy mode. If the current mode is the copy mode, the screen operation processor 410 switches the mode to the selection mode in step S1515; otherwise, the screen operation processor 410 switches the mode to the copy mode in step S1517. Note that mode switching by a center touch is not limited to this, as described above.

If the operation is not a center touch, the screen operation processor 410 determines in step S1521 whether the operation is a right touch. If the operation is a right touch, the screen operation processor 410 moves, in step S1523, the selected range rightward by one character. In the case of the right end, the screen operation processor 410 moves the selected range to the lower line.

If the operation is neither a center touch nor a right touch, the screen operation processor 410 determines in step S1531 whether the operation is a left touch. If the operation is a left touch, the screen operation processor 410 moves, in step S1533, the selected range leftward by one character. In the case of the left end, the screen operation processor 410 moves the selected range to the upper line.

Note that this embodiment has exemplified the case of horizontal writing. In the case of vertical writing as well, setting and adjustment of the selected range can be implemented in the same manner.

According to this embodiment, it is possible to move the selected range rightward or leftward by one character by a right or left touch on the icon, thereby making an actually selected target accurately coincide with a target the user wants to select from the display document.

### Fourth Embodiment

An information processing apparatus according to the fourth embodiment of the present invention will be described next. The information processing apparatus according to this embodiment is different from those according to the second and third embodiments in that the size of a selected range is changed in a word unit by a touch operation on an icon. The remaining components and operations are the same as those in the second or third embodiment. Hence, the same reference numerals denote the same components and operations, and a detailed description thereof will be omitted.

(Range Selection of Embodiment)

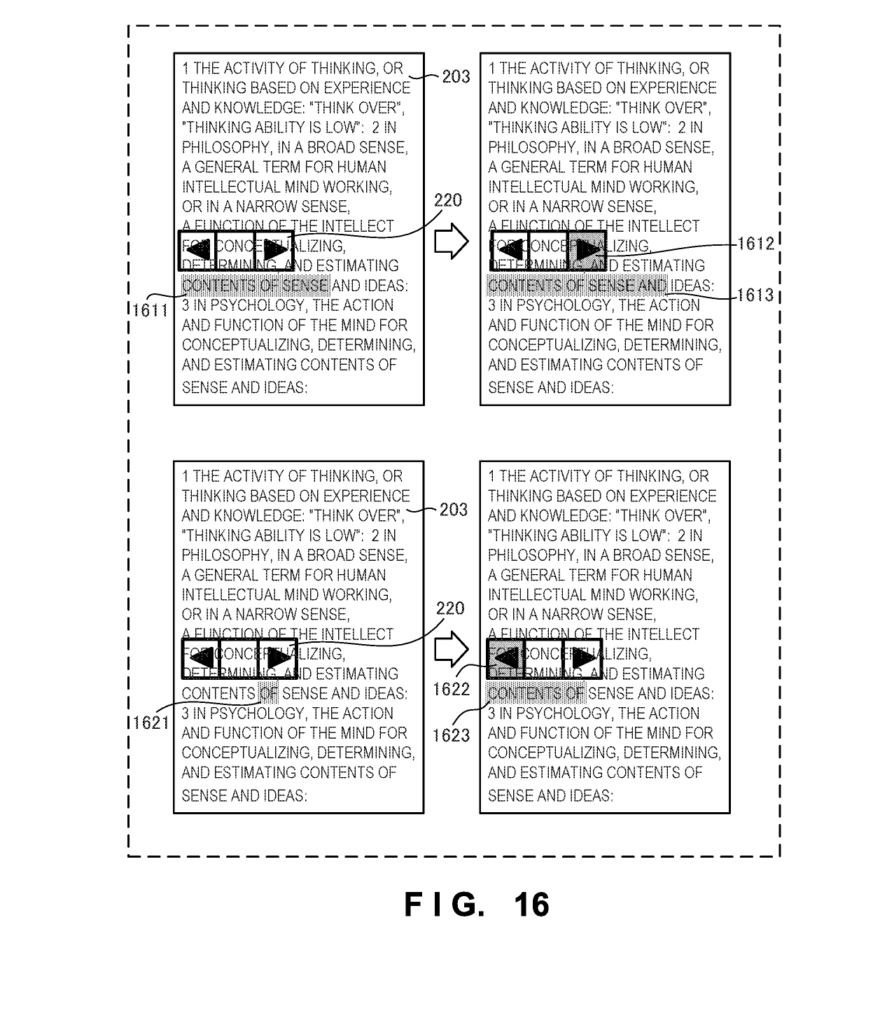

FIG. 16 is a view for explaining range selection in the information processing apparatus according to this embodiment. FIG. 16 shows an example of displaying a translucent icon but the present invention is not limited to this. Note that in FIG. 16, the same reference numerals denote the same components as in FIG. 2.

The upper left view of FIG. 16 shows a state in which “contents of sense” 1611 has been designated in a display document 203 selected by the user. The upper right view of FIG. 16 shows a state in which the “contents of sense” 1611 of the selected range is enlarged by one word to “contents of sense and” 1613 by a right touch 1612 on an icon 220.

The lower left view of FIG. 16 shows a state in which “of” 1621 has been designated in the display document 203 selected by the user. The lower right view of FIG. 16 shows a state in which the “of” 1621 of the selected range has been enlarged by one word to “contents of” 1623 by a left touch 1622 on the icon 220.

Note that FIG. 16 shows enlargement of the selected range but reduction is also possible. FIG. 16 shows a case for clearly explaining an example of adjustment of the selected range according to this embodiment. In fact, however, it is often controlled to select a word even by designating part of the word.

(Icon Generator)

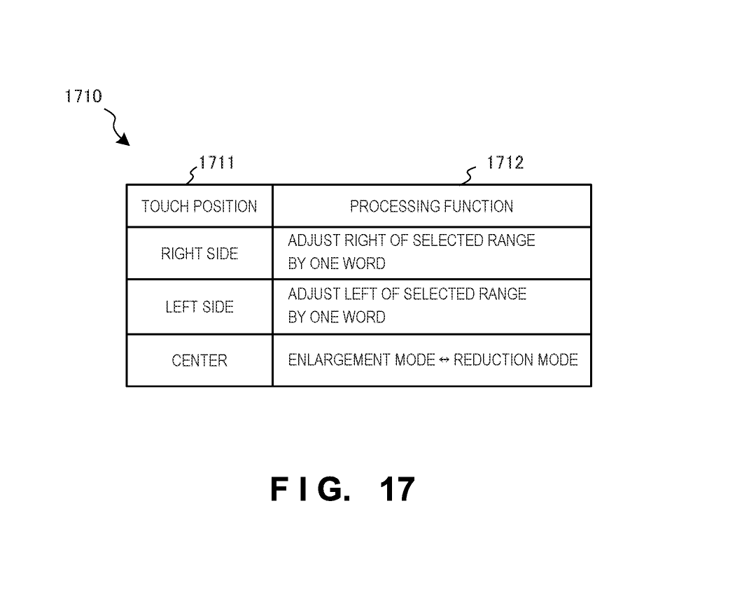

FIG. 17 is a table showing the structure of an icon function table 1710 according to this embodiment. The icon function table 1710 stores a function set by an icon function setting unit 801 according to this embodiment. Processing corresponding to the touch position of the icon in the icon function table 1710 is used by a user operation determiner 560.

The icon function table 1710 stores a processing function 1712 in correspondence with a touch position 1711. In this embodiment, if the right side of the icon is touched, the right of the selected range is adjusted by one word in accordance with a mode. If the left side of the icon is touched, the left of the selected range is adjusted by one word in accordance with the mode. If the center of the icon is touched, the mode is switched between an enlargement mode for enlarging the selected range and a reduction mode for reducing the selected range. Note that mode setting by a center touch on the icon is not limited to this. For example, a switch for switching whether or not to adjust the selected range may be adopted, or the mode may be switched between a selected range adjustment mode and a copy mode for storing the selected range.

(Selected Range Adjustment Processing)

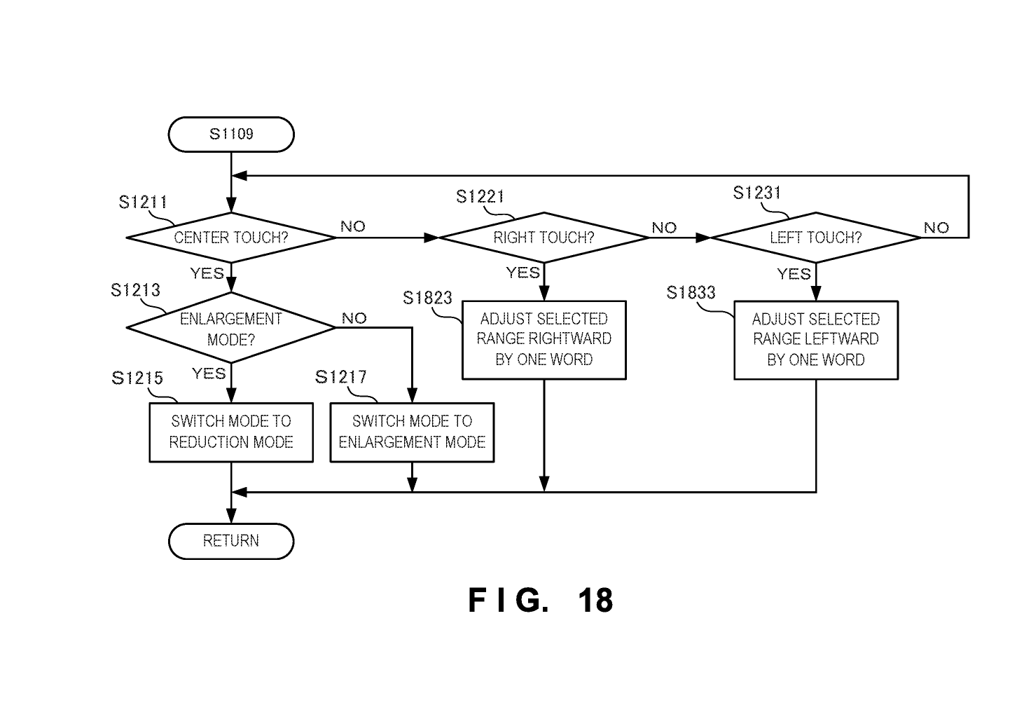

FIG. 18 is a flowchart illustrating the procedure of selected range adjustment processing (S1109) according to this embodiment. Note that in FIG. 18, the same step numbers as in FIG. 12B denote the same steps and a description thereof will be omitted.

If the operation is not a center touch but a right touch, a screen operation processor 410 adjusts, in step S1823, the selected range rightward by one word in accordance with the mode. In the case of the extension mode at the right end, the selected range is extended to the left end of the lower line. In the case of the reduction mode at the left end, the selected range is reduced to the right end of the upper line.

If the operation is neither a center touch nor a right touch but is a left touch, the screen operation processor 410 adjusts, in step S1833, the selected range leftward by one word in accordance with the mode. In the case of the enlargement mode at the left end, the selected range is extended to the right end of the upper line. In the case of the reduction mode at the right end, the selected range is reduced to the left end of the lower line.

Note that this embodiment has exemplified the case of horizontal writing. In the case of vertical writing as well, setting and adjustment of the selected range can be implemented in the same manner.

According to this embodiment, it is possible to adjust the size of the selected range rightward or leftward by one word by a right or left touch on the icon, thereby quickly making an actually selected target coincide with a target the user wants to select from the display document.

### Fifth Embodiment

An information processing apparatus according to the fifth embodiment of the present invention will be described next. The information processing apparatus according to this embodiment is different from those according to the second to fourth embodiments in that the position of a selected range is moved in a word unit by a touch operation on an icon. The remaining components and operations are the same as those in the second to fourth embodiments. Hence, the same reference numerals denote the same components and operations, and a detailed description thereof will be omitted.

(Range Selection of Embodiment)

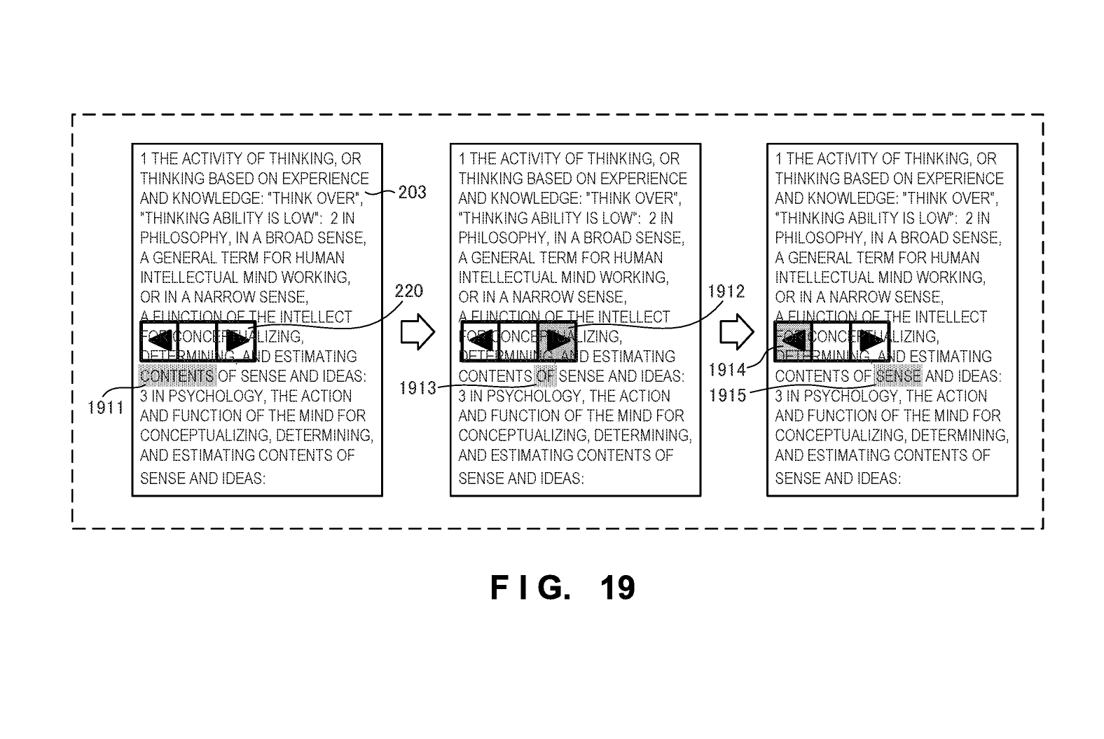

FIG. 19 is a view for explaining range selection in the information processing apparatus according to this embodiment. FIG. 19 shows an example of displaying a translucent icon but the present invention is not limited to this. Note that in FIG. 19, the same reference numerals denote the same components as in FIG. 2.

The left view of FIG. 19 shows a state in which “contents” 1911 has been designated in a display document 203 selected by the user. The central view of FIG. 19 shows a state in which the “contents” 1911 has been moved by one word to “of” 1913 by a right touch 1912 on an icon 220. The right view of FIG. 19 shows a state in which the “of” 1913 has been moved by one word to “sense” 1915 by a further right touch 1914 on the icon 220.

(Icon Generator)

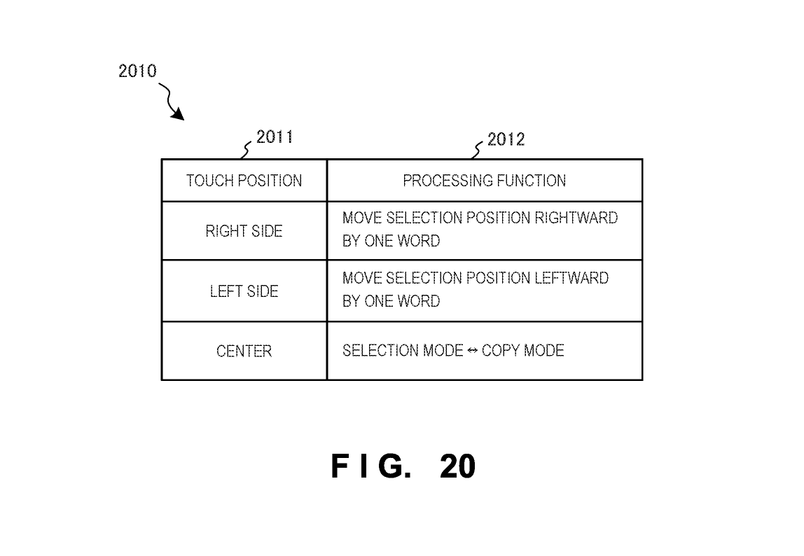

FIG. 20 is a table showing the structure of an icon function table 2010 according to this embodiment. The icon function table 2010 is set by an icon generator 540, and used by a user operation determiner 560 to adjust a selected range.

The icon function table 2010 stores a processing function 2012 in correspondence with a touch position 2011. In this embodiment, if the right side of the icon is touched, the position of the selected range is moved rightward by one word. If the left side of the icon is touched, the position of the selected range is moved leftward by one word. If the center of the icon is touched, the mode is switched between a selection mode for setting a selected range and a copy mode for storing a selected range for a copy. Note that mode setting by a center touch on the icon is not limited to this. For example, a switch for switching whether or not to adjust the selected range may be adopted.

(Selected Range Adjustment Processing)

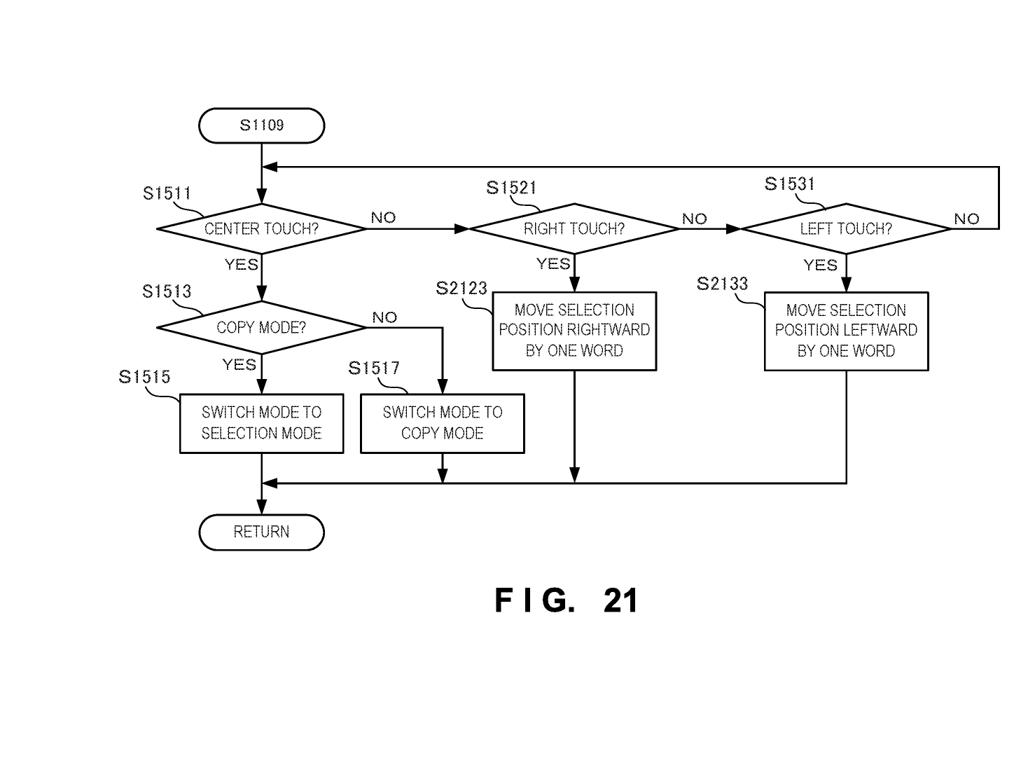

FIG. 21 is a flowchart illustrating the procedure of selected range adjustment processing (S1109) according to this embodiment. Note that in FIG. 21, the same step numbers as in FIG. 14 denote the same steps and a description thereof will be omitted.

If the operation is not a center touch but a right touch, a screen operation processor 410 moves, in step S2123, the selected range rightward by one word. In the case of the right end, the screen operation processor 410 moves the selected range to the lower line.

If the operation is neither a center touch nor a right touch but is a left touch, the screen operation processor 410 moves, in step S2133, the selected range leftward by one word. In the case of the left end, the screen operation processor 410 moves the selected range to the upper line.

Note that this embodiment has exemplified the case of horizontal writing. In the case of vertical writing as well, setting and adjustment of the selected range can be implemented in the same manner.

According to this embodiment, it is possible to move the selected range rightward or leftward by one character by a right or left touch on the icon, thereby quickly making an actually selected target coincide with a target the user wants to select from the display document.

### Sixth Embodiment

An information processing apparatus according to the sixth embodiment of the present invention will be described next. The information processing apparatus according to this embodiment is different from those according to the second to fifth embodiments in that an adjustment unit of a selected range is selected by a touch operation on an icon. For example, a word unit, phrase unit, sentence unit, paragraph unit, or the like is selected as an adjustment unit. The remaining components and operations are the same as those in the second to fifth embodiments. Hence, the same reference numerals denote the same components and operations, and a detailed description thereof will be omitted.

(Icon Generator)

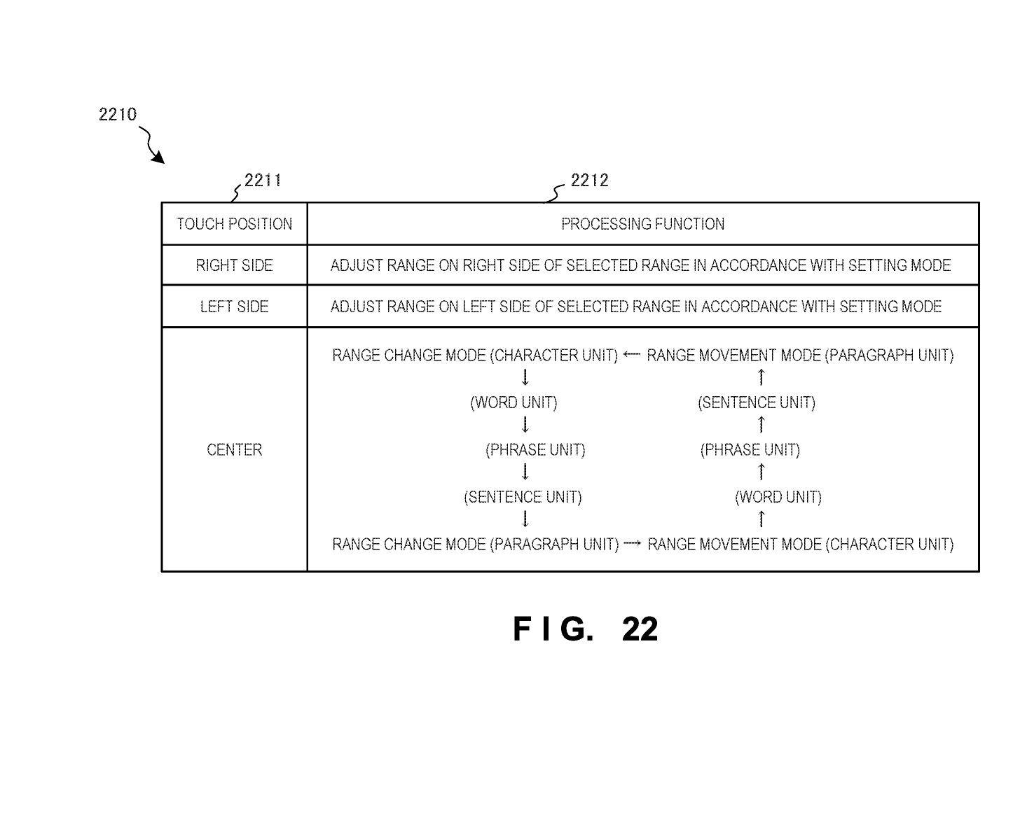

FIG. 22 is a table showing the structure of an icon function table 2210 according to this embodiment. The icon function table 2210 is set by an icon generator 540, and used by a user operation determiner 560 to adjust a selected range.

The icon function table 2210 stores a processing function 2212 in correspondence with a touch position 2211. In this embodiment, if the right side of the icon is touched, a range on the right side of the selected range is adjusted in accordance with a setting mode. If the left side of the icon is touched, a range on the left side of the selected range is adjusted in accordance with the setting mode. If the center of the icon is touched, the mode is switched between a range change mode (a change of the size of the selected range) and a range movement mode (movement of the position of the selected range), and the change unit or movement unit is switched in the order of character→word→phrase→sentence→paragraph, thereby functioning as a switch.

Note that mode setting by a center touch on the icon is not limited to this. For example, the change order need not be that shown in FIG. 22.

(Selected Range Adjustment Processing)

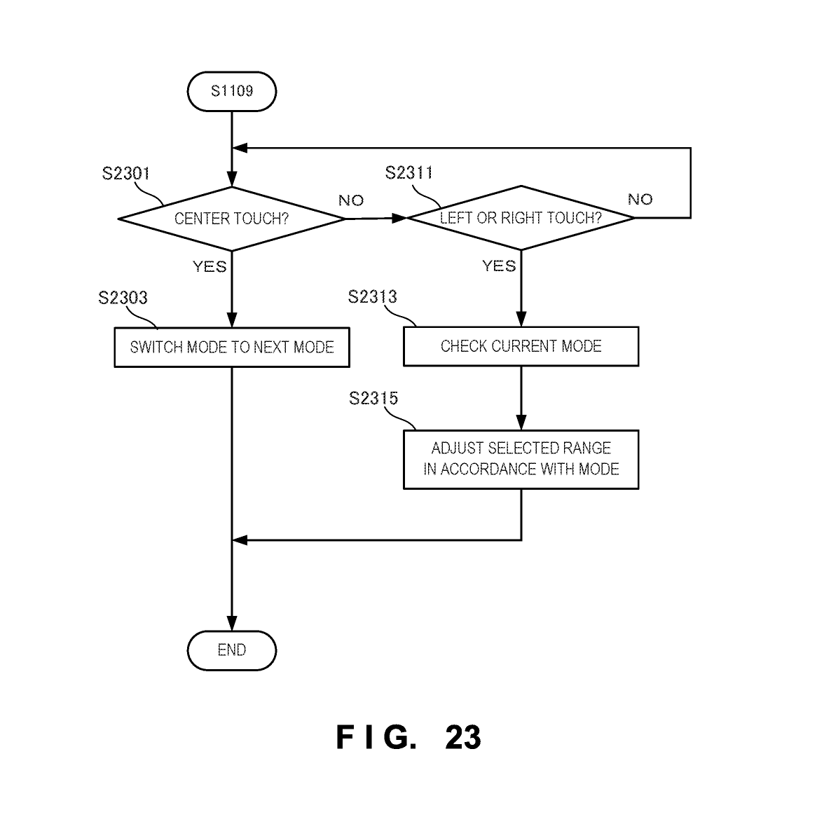

FIG. 23 is a flowchart illustrating the procedure of selected range adjustment processing (S1109) according to this embodiment.

In step S2301, a screen operation processor 410 determines whether the operation is a center touch on the icon. If the operation is a center touch, the screen operation processor 410 switches the mode to the next mode in step S2303.

If the operation is not a center touch, the screen operation processor 410 determines in step S2311 whether the operation is a left touch or right touch. If the operation is a left touch or left touch, the screen operation processor 410 checks the current mode in step S2313. In step S2315, the screen operation processor 410 adjusts the selected range based on the left touch or left touch in accordance with the current mode.

According to this embodiment, the user can change an adjustment width or the like by switching the selected range adjustment mode, thereby freely making an actually selected target coincide with a target the user wants to select from a display document.

### Seventh Embodiment

An information processing apparatus according to the seventh embodiment of the present invention will be described next. The information processing apparatus according to this embodiment is different from those according to the second to sixth embodiments in that the start and end points of a selected range are determined by touch operations on an icon. In this embodiment, the icon is a cross icon, thereby allowing upward, downward, rightward, or leftward movement of the start and end points. The remaining components and operations are the same as those in the second to sixth embodiments. Hence, the same reference numerals denote the same components and operations, and a detailed description thereof will be omitted.

(Range Selection of Embodiment)

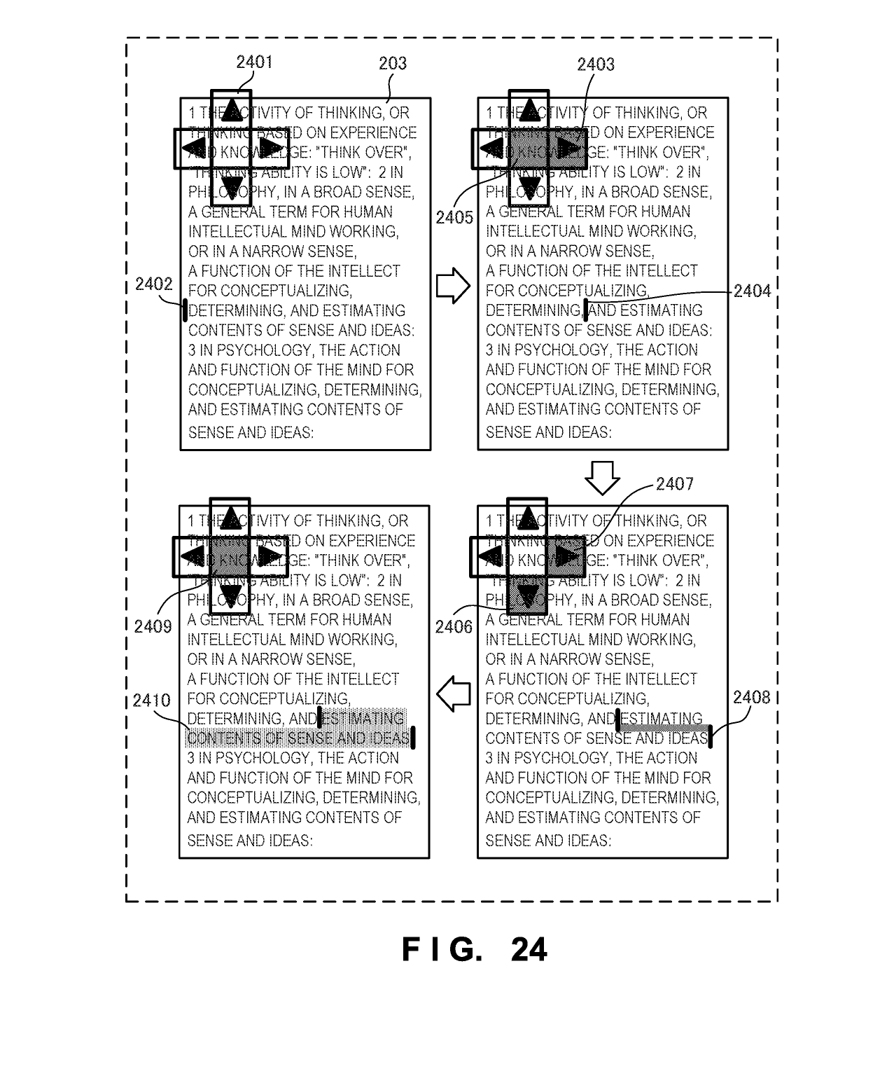

FIG. 24 is a view for explaining range selection in the information processing apparatus according to this embodiment. FIG. 24 shows an example of displaying a translucent icon but the present invention is not limited to this. Note that in FIG. 24, the same reference numerals denote the same components as in FIG. 2. FIG. 24 shows an example in which an operation moves in the order of upper left upper right lower right lower left.

Referring to FIG. 24, a cross icon 2401 is displayed.

The upper left view of FIG. 24 shows a state in which a start point 2402 of a selected range has been designated at a position before “determining” in a display document 203 selected by the user. At this time, the mode is a start point determination mode. The upper right view of FIG. 24 shows a state in which a start point 2404 has been moved by one word to a position before “and” by a right touch 2403 on the icon 2401. The start point 2404 is confirmed by a center touch 2405 on the icon 2401, and the mode is switched to an end point determination mode.

The lower right view of FIG. 24 shows a state in which an end point has been moved to the lower line by a lower touch 2406 on the icon 2401, and an end point 2408 has been moved to a position after “ideas” by a right touch 2407. The lower left view of FIG. 24 shows a state in which the end point has been confirmed by a center touch 2409 on the icon 2401, thereby determining “and estimating contents of sense and ideas” as a selected range.

Note that movement of the start and end points of the selected range in FIG. 24 may be configured to be able to select a movement unit, similarly to the sixth embodiment.

(Icon Generator)

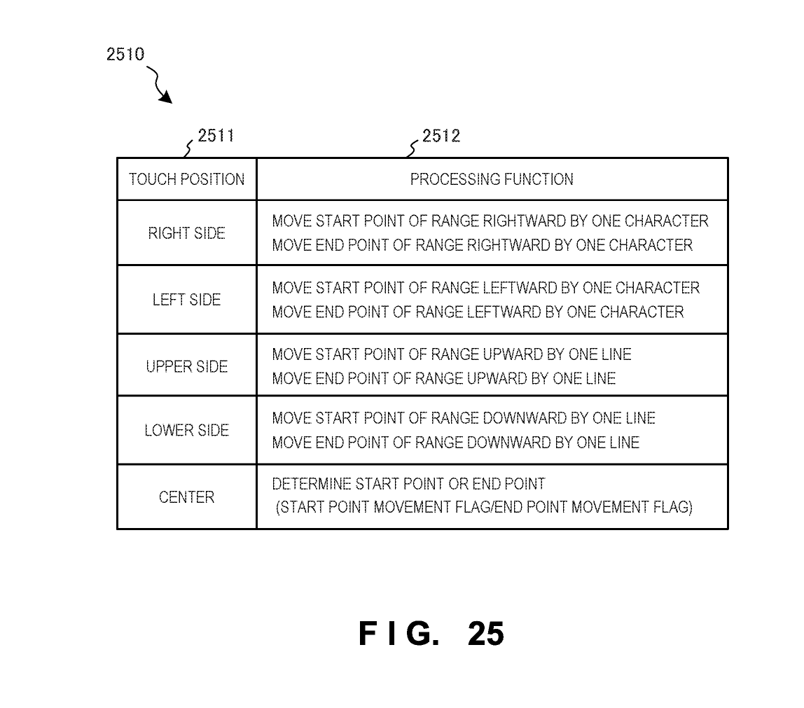

FIG. 25 is a table showing the structure of an icon function table 2510 according to this embodiment. The icon function table 2510 is set by an icon generator 540, and used by a user operation determiner 560 to adjust a selected range.

The icon function table 2510 stores a processing function 2512 in correspondence with a touch position 2511. In this embodiment, if the right side of the icon is touched, the start or end point of the range is moved rightward by one character in accordance with the setting mode. If the left side of the icon is touched, the start or end point of the range is moved leftward by one character in accordance with the setting mode. If the upper side of the icon is touched, the start or end point of the range is moved upward by one line in accordance with the setting mode. If the lower side of the icon is touched, the start or end point of the range is moved downward by one line in accordance with the setting mode.

If the center of the icon is touched, the mode is switched between the start point determination mode (confirmation of the start point of the selected range) and the end point determination mode (confirmation of the end point of the selected range). Note that mode setting by a center touch on the icon is not limited to this.

(Selected Range Adjustment Processing)

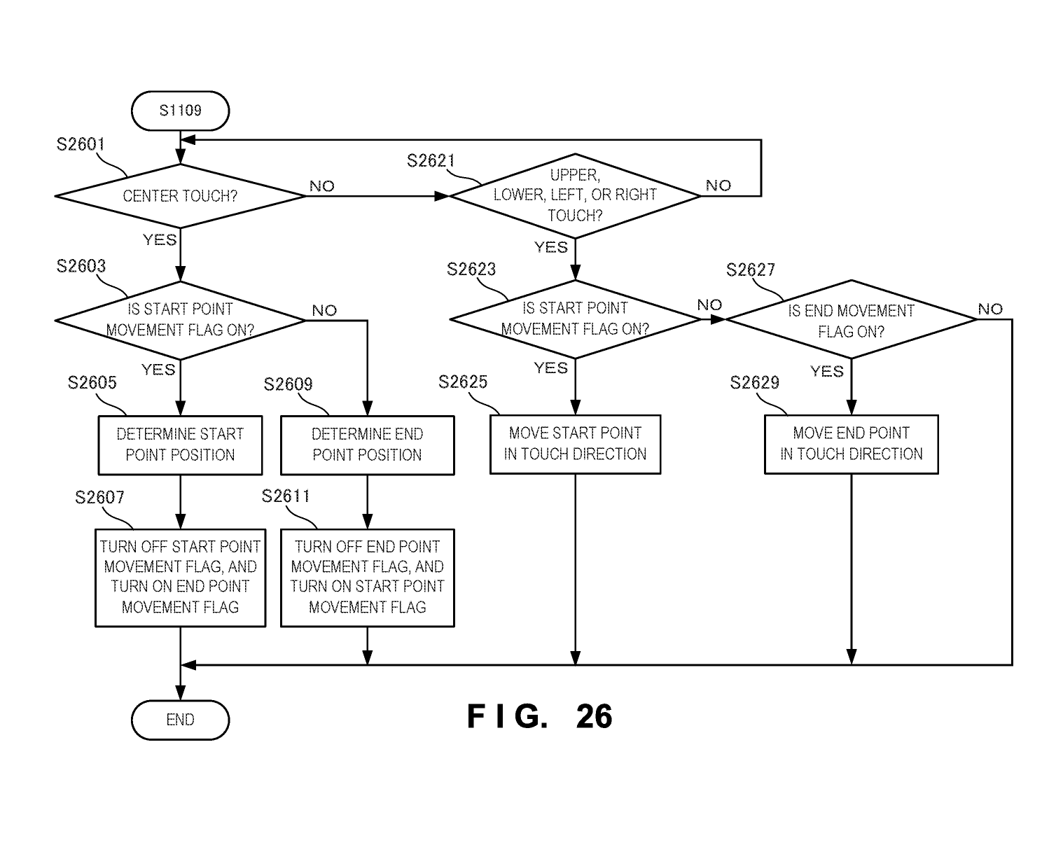

FIG. 26 is a flowchart illustrating the procedure of selected range adjustment processing (S1109) according to this embodiment.

In step S2601, a screen operation processor 410 determines whether the operation is a center touch on the icon. If the operation is a center touch, the screen operation processor 410 determines in step S2603 whether a start point movement flag is ON, that is, whether the mode is the start point determination mode. If the start point movement flag is ON, the screen operation processor 410 determines the current position as a start point position in step S2605. In step S2607, the screen operation processor 410 turns off the start point movement flag, and turns on an end point movement flag. On the other hand, if it is determined in step S2603 that the start point movement flag is OFF (that is, the end point movement flag is ON), the screen operation processor 410 determines the current position as an end point position in step S2609. In step S2611, the screen operation processor 410 turns off the end point movement flag, and turns on the start point movement flag. The mode is switched to the next mode.

If the operation is not a center touch, the screen operation processor 410 determines in step S2621 whether the operation is an upper, lower, right, or left touch. If the operation is an upper, lower, right, or left touch, the screen operation processor 410 determines in step S2623 whether the start point movement flag is ON, that is, whether the mode is the start point determination mode. If the start point movement flag is ON, the screen operation processor 410 moves the start point in the touch direction in step S2625; otherwise, the screen operation processor 410 determines in step S2627 whether the end point movement flag is ON. If the end point movement flag is ON, the screen operation processor 410 moves the end point in the touch direction in step S2629.

According to this embodiment, the start or end point of the selected range can be independently adjusted, thereby freely making an actually selected target coincide with a target the user wants to select from a display document.

### OTHER EMBODIMENTS

In the above embodiments, selection of document elements from a display document in a smartphone or tablet for which the user performs an input or instruction operation using a touch panel has been explained. Application of the technique according to the present invention is not limited to the smartphone or tablet. The technique is applicable to another information processing apparatus for which the user performs an input or instruction operation using a touch panel and to selection of document elements from a display document using a keyboard or pointing device without limitation to the touch panel.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when an information processing program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-059237 filed on Mar. 20, 2014, which is hereby incorporated by reference herein in its entirety.

1. An information processing apparatus comprising:
a touch panel;
a display unit that displays a document and a selected range in the document in correspondence with said touch panel; and
an adjuster that adjusts the selected range in accordance with a touch operation on an icon by causing said display unit to display the icon while the selected range is displayed.

2. The information processing apparatus according to claim 1, wherein said adjuster performs one of an operation of moving a position of the selected range and an operation of changing a size of the selected range in accordance with a position of the touch operation on the icon.

3. The information processing apparatus according to claim 1, wherein said adjuster adjusts the selected range in one of a character unit and a word unit.

4. The information processing apparatus according to claim 1, further comprising:
a selector that selects, in the touch operation on the icon, in accordance with the position of the touch operation on the icon, a unit for adjusting the selected range,
wherein said adjuster adjusts the selected range in the unit selected by said selector.

5. The information processing apparatus according to claim 1, further comprising:
a switch that switches whether a start point or end point of the selected range is adjusted, in the touch operation on the icon in accordance with a position of the touch operation on the icon,
wherein said adjuster adjusts one of the start point and end point of the selected range in accordance with switching by said switch.

6. The information processing apparatus according to claim 1, wherein said adjuster adjusts a display position to display the icon at a position which does not overlap the selected range.

7. The information processing apparatus according to claim 1, wherein said adjuster causes said display unit to display the translucent icon.

8. The information processing apparatus according to claim 1, wherein said adjuster causes said display unit to display the icon in accordance with detection of a touch operation on the selected range.

9. An information processing method comprising:
displaying a document and a selected range in the document on a display unit in correspondence with a touch panel; and
adjusting the selected range in accordance with a touch operation on an icon by causing the display unit to display the icon while the selected range is displayed.

10. A non-transitory computer readable medium storing a program for causing a computer to execute a method, comprising:
displaying a document and a selected range in the document on a display unit in correspondence with a touch panel; and
adjusting the selected range in accordance with a touch operation on an icon by causing the display unit to display the icon while the selected range is displayed.
